(19) United States
(12) Patent Application Publication
(10) Pub. No.: US 2007/0142224 A1
(43) Pub. Date: Jun. 21, 2007

(54) DeNOx catalyst preparation method

(76) Inventors: M. Kamal Akhtar, Ellicott City, MD (US); Steven M. Augustine, Ellicott City, MD (US)

Correspondence Address: LYONDELL CHEMICAL COMPANY, 3801 WEST CHESTER PIKE, NEWTOWN SQUARE, PA, 19073, US

(21) Appl. No.: 11/303,625

(22) Filed: Dec. 16, 2005

(51) Int. Cl. B01J 23/00

(52) U.S. Cl. 502/309

(57) ABSTRACT

The invention is a method for producing a metal oxide catalyst useful for purifying exhaust gases and waste gases from combustion processes. The method comprises reacting a titanium dioxide precursor, a vanadium oxide precursor, and a tungsten oxide precursor in the presence of oxygen at a temperature of at least 1000° C.

### FIELD OF THE INVENTION

This invention relates to a process to produce metal oxide catalysts. The catalysts are useful for purifying exhaust gases and waste gases from combustion processes.

### BACKGROUND OF THE INVENTION

The high temperature combustion of fossil fuels or coal in the presence of oxygen leads to the production of unwanted nitrogen oxides (NOₓ). Significant research and commercial efforts have sought to prevent the production of these well-known pollutants, or to remove these materials prior to their release into the air. Additionally, federal legislation has imposed increasingly more stringent requirements to reduce the amount of nitrogen oxides released to the atmosphere.

Processes for the removal of NOₓ from combustion exit gases are well known in the art. The selective catalytic reduction process is particularly effective. In this process, nitrogen oxides are reduced by ammonia (or another reducing agent such as unburned hydrocarbons present in the waste gas effluent) in the presence of a catalyst with the formation of nitrogen. Effective selective catalytic reduction DeNOₓ catalysts include a variety of mixed metal oxide catalysts, including vanadium oxide supported on an anatase form of titanium dioxide (see, for example, U.S. Pat. No. 4,048,112) and titania and at least one oxide of molybdenum, tungsten, iron, vanadium, nickel, cobalt, copper, chromium or uranium (see, for example, U.S. Pat. No. 4,085,193).

A particularly effective catalyst for the selective catalytic reduction of NOₓ is a metal oxide catalyst comprising titanium dioxide, divanadium pentoxide, and tungsten trioxide and/or molybdenum trioxide (U.S. Pat. No. 3,279,884). The current process of making these catalysts is a multi-step process where the titanium dioxide precursor (hydrolysate) from the sulfate process is first precipitated in an aqueous sol-gel process, then the tungsten precursor (usually ammonium paratungstate) is deposited onto the precipitated material, the mixture is de-watered, dried, and finally calcined to the desired crystallinity to obtain a titanium dioxide material with tungsten oxide on the surface (see, for example, U.S. Pat. Nos. 3,279,884 and 4,085,193). Commonly, vanadia precursor is also dispersed onto the titanium dioxide-tungsten oxide material in a subsequent step to impart high activity to the catalyst, and this requires another deposition and calcination procedure.

Co-pending U.S. application Ser. No. 10/968,706 teaches a method of producing a catalyst comprised of titanium dioxide, vanadium oxide and a supported metal oxide. The supported metal oxide (one or more of W, Mo, Cr, Sc, Y, La, Zr, Hf, Nb, Ta, Fe, Ru, and Mn) is first supported on the titanium dioxide prior to depositing vanadium oxide. The titania supported metal oxide has an isoelectric point of less than or equal to a pH of 3.75 prior to depositing the vanadium oxide.

In sum, new catalysts and new catalyst preparation methods are required for the development of improved selective catalytic reduction processes to remove nitrogen oxides prior to their release into the atmosphere. Single-step processes to efficiently produce catalysts with reduced expenditure of capital, time and energy are particularly desirable.

### SUMMARY OF THE INVENTION

The invention is a method for producing metal oxides useful as DeNOₓ catalysts. The method comprises reacting a titanium dioxide precursor, a vanadium oxide precursor, and a tungsten oxide precursor in the presence of oxygen at a temperature of at least 1000° C. The catalysts produced by the method of the invention are surprisingly more effective for the destruction of nitrogen oxides by ammonia as compared to catalysts produced by conventional methods.

### DETAILED DESCRIPTION OF THE INVENTION

The method of the invention comprises reacting a titanium dioxide precursor, a vanadium oxide precursor, and a tungsten oxide precursor in the presence of oxygen at a temperature of at least 1000° C. Titanium dioxide precursors are titanium-containing compounds that form titanium dioxide when subjected to high temperatures in the presence of oxygen. Although the process of the invention is not limited by choice of a particular titanium dioxide precursor, suitable titanium compounds useful in the invention include, but are not limited to, titanium alkoxides and titanium halides. Preferred titanium alkoxides are titanium tetraisopropoxide, titanium tetraethoxide and titanium tetrabutoxide. Titanium tetraethoxide is especially preferred. Preferred titanium halides include titanium trichloride and titanium tetrachloride.

Vanadium oxide precursors are vanadium-containing compounds that form vanadium oxide when subjected to high temperatures in the presence of oxygen. Although the process of the invention is not limited by choice of a particular vanadium oxide precursor, suitable vanadium compounds useful in the invention include, but are not limited to, vanadium halides, vanadium oxyhalides, vanadium alkoxides and vanadium acetylacetonate.

Tungsten oxide precursors are tungsten-containing compounds that form tungsten oxide when subjected to high temperatures in the presence of oxygen. Although the process of the invention is not limited by choice of a particular tungsten oxide precursor, suitable tungsten compounds useful in the invention include, but are not limited to, tungsten alkoxides, tungsten halides, tungsten oxyhalides, tungstic acid, and ammonium tungstate.

The metal oxide catalyst preferably comprises from 0.1 to 20 weight percent tungsten oxide, from 0.2 to 10 weight percent vanadium oxide, with the balance titanium dioxide; more preferably from 4 to 15 weight percent tungsten oxide and from 1 to 3 weight percent vanadium oxide.

To increase the thermal stability of the metal oxide catalyst, it may be advantageous to add additional oxide precursors. Suitable additives include silica sources, alumina sources, ceria sources, lanthana sources, zirconia sources, and mixtures thereof. The additives are compounds that form silica, alumina, ceria, lanthana, or zirconia when subjected to high temperatures in the presence of oxygen.

Suitable silica sources include, but are not limited to, silicon alkoxides, silicon halides, and silanes. Preferred silicon alkoxides are tetraethylorthosilicate, tetramethylorthosilicate, and the like. Tetraethylorthosilicate is especially preferred. Preferred silanes include hydrosilanes, alkylsilanes, alkylalkoxy-silanes, and alkylhalosilanes. Suitable alumina sources include, but are not limited to, aluminum halides, aluminum trialkoxides such as aluminum triisopropoxide, and aluminum acetylacetonate. Suitable ceria sources include, but are not limited to, cerium halides, cerium alkoxides, cerium acetate, and cerium acetylacetonate. Suitable lanthana sources include, but are not limited to, lanthanum halides, lanthanum alkoxides, lanthanum acetate, and lanthanum acetylacetonate. Suitable zirconia sources include, but are not limited to, zirconium alkoxides, zirconium halides, zirconium oxyhalides, zirconium acetate, and zirconium acetylacetonate.

If an additional oxide precursor is used, the metal oxide catalyst will preferably contain from 1 to 20 weight percent of the additional oxide, more preferably from 2 to 10 weight percent.

The method of the invention comprises reacting the oxide precursors above in the presence of oxygen at a temperature of at least 1000° C. Preferably, the reaction occurs at a temperature in the range of 1200 to 3000° C. The reaction pressure is preferred to be in the range of 5 to 100 psig.

Oxygen is required in the process. Although any sources of oxygen are suitable, molecular oxygen is preferred. The amount of oxygen is preferably greater than about 10% above stoichiometric for the amount required for the complete combustion of the titanium dioxide, tungsten oxide, vanadium oxide and additional metal oxide precursors, in order to avoid unreacted precursors.

The high temperature reaction of metal oxide precursors in the presence of oxygen to produce metal oxides is well known to those skilled in the art. Any of these known methods are suitable for the present invention. For instance, there are many commercial and published methods for producing titanium dioxide particles by reacting titanium dioxide precursors and oxygen in a high temperature reaction zone. For example, U.S. Pat. No. 3,512,219 describes high temperature processes and apparatus for the manufacture of titanium dioxide. U.S. Pat. No. 6,627,173 teaches a process of making titanium dioxide doped with zinc oxide, magnesium oxide and aluminum oxide wherein titanium tetrachloride is vaporized prior to entering the flame oxidation or flame hydrolysis reactor. As another example, U.S. Pat. No. 5,075,090 discloses a process in which an organometallic titanium precursor is dissolved in an organic solvent and sprayed into a high temperature combustion zone. The reaction between the titanium dioxide precursor and oxygen at elevated temperatures is extremely fast and yields titanium dioxide.

The process of the present invention may take place in any known reactor that is suitable for high temperature oxidation reactions. With a view to practicing the present invention, any conventional type of corrosion resistant reaction vessel may be employed. The vessel must be of such design, construction and dimension that preferably a continuous flow of reactants and products within and through the reaction zone(s) will be afforded and control over the velocities, mixing rates, temperatures, and thus residence times distributions, will be permitted. For instance, different reactor configurations with multiple titanium dioxide precursor feed streams have been used to produce titanium dioxide as described in U.S. Pat. No. 6,387,347, the teachings of which are incorporated herein by reference.

The preferred residence time for the reaction of the various metal oxide precursors in the presence of oxygen is in the range of 0.1 to 100 milliseconds, most preferably between 0.2 and 2 milliseconds. Mean residence time (t) is a function of the volume of the reactor (V), and the volumetric flow rate of the reactants (Q), and may be simply stated as:
t=(Q/V)

Typically, the longer the mean residence time (at a given temperature and pressure), the larger the particles. In practice, the distribution of residence times within a reaction vessel is a complex function of mixing intensity, density of gases and temperature profiles. The desired residence time required can be calculated from well-known theories of fluid mechanics and particle growth. To practice the present inventive process, the physical parameters of a reaction zone of a reactor are adjusted for anticipated process conditions as described by the equation (above) to achieve the desired particle size and specific surface area.

The flow may be controlled by, for example, adjusting the width of the slots or orifices through which the metal oxide precursors enter the reaction zone. As one of ordinary skill will understand, provided there is sufficient energy to drive the reactants through, an increase in slot width will generally increase the droplet size of the reactants and lead to larger particles with lower specific surface area.

The titanium dioxide precursor, vanadium oxide precursor, tungsten oxide precursor, and, optionally, the additional oxide precursor may be added to the reaction zone as vapors or they may be dissolved in organic solvents. Preferably, the oxide precursors are dissolved in organic solvents prior to introduction into the reaction zone. It is particularly preferred that the oxide precursors are dissolved in an organic solvent and sprayed into a flame oxidation reaction zone, especially in the form of an aerosol. Any of the conventional apparatus for droplet generation may be used to prepare the aerosols, including centrifugal atomizers, two-fluid atomizers, electrospray atomizers, nebulizers, Collison nebulizers, ultrasonic nebulizers, vibrating orifice aerosol generators, and the like.

The particle size of the catalyst particles depends on the efficiency of the atomizing device and the concentration of the precursors in the solution. The average diameter of the droplets can vary depending on the details of the reactor setup, the amount of dispersion gas used and the properties of the solution (density, surface tension and viscosity). The usual droplet diameter ranges from 0.2 μm to 200 μm, preferably in the range of 2 to 20 μm. It is preferable to maintain the concentration in the range of 2-25 weight percent.

The organic solvents used to dissolve the precursors can be methanol, ethanol, iso-propanol, n-propanol, xylene, toluene and the like. If a solvent is used, xylene and toluene are particularly preferred. For a flame oxidation reaction, the enthalpy content of the solvent is important to maintain the flame temperature at the desired level between 1500 and 2200 K. This requires a net heat of combustion between 10 and 30 kJ/gm.

In addition to the metal oxide precursors, a carrier gas is preferably employed. Examples of suitable carrier gases include air, nitrogen, oxygen, steam, argon, helium, carbon dioxide and the like. Of these, air and nitrogen are preferred.

The order of addition of the titanium dioxide precursor, vanadium oxide precursor, tungsten oxide precursor, and, optionally, the additional oxide precursor, is not critical to the method of the invention. In one embodiment of the invention, the titanium dioxide precursor, vanadium oxide precursor, tungsten oxide precursor, and, optionally, the additional oxide precursor, are fed simultaneously into the high temperature reaction zone. In another embodiment of the invention, the various precursors are added separately to the high temperature reaction zone.

For a flame oxidation process, the reactants being introduced into the reactor are ignited by means of pilot flames of natural gas or they may be ignited by any other means like lasers, electrical discharge and heated wires.

Following reaction and catalyst particle formation, the metal oxide catalyst is preferably separated from the carrier gas and reaction by-products, and then collected by one or more devices such as filters, cyclones, electrostatic separators, bag filters, filter discs, scrubbers and the like. The gas upon completion of the reaction consists of the carrier gas, decomposition products of the oxide precursor compounds and solvent vapor.

It has also been found, surprisingly and unexpectedly, that the metal oxide catalysts produced by the method of the invention are more effective in the selective catalytic reduction of nitrogen oxides by ammonia as compared to catalysts produced by conventional methods. Moreover, even though they are produced at a high temperature, the desired anatase phase is dominant (>90 wt % anatase).

The following examples merely illustrate the invention. Those skilled in the art will recognize many variations that are within the spirit of the invention and scope of the claims.

### COMPARATIVE EXAMPLE 1

### Conventional Catalyst Preparation

Comparative Catalyst 1A

Monoethanolamine (0.185 g), deionized water (20 mL), and vanadium pentoxide (0.184 g) are mixed at 60° C. in a 25 mL flask until the vanadium pentoxide dissolves. Then, 10 wt. % tungsten oxide supported on anatase titanium dioxide (10 g, DT 52 from Millennium Inorganic Chemicals, Inc.) is stirred in the solution. The solvent is evaporated under vacuum, and the powder is dried at 110° C. overnight. The dried sample is calcined in air at 600° C. for 6 hours to produce Comparative Catalyst 1A. The final vanadium pentoxide loading is 1.8 wt. %.

Comparative Catalyst 1B

1B is prepared according to the procedure of 1A, with the exception that the titania support is replaced with a 10 wt. % tungsten oxide and 9 wt. % silica supported on anatase titanium dioxide (10 g, DT 58 from Millennium Inorganic Chemicals, Inc.).

### EXAMPLE 2

### Flame Spray Synthesis of Catalysts

Catalyst 2A

A precursor solution resulting in powders of 10 wt. % tungsta, 1.8 wt. % vanadia, and the balance TiO₂ is prepared by dissolving titanium isopropoxide (40.6 g), tungsten ethoxide (2.3 g), vanadium isopropoxide (0.76 g) in toluene (300 mL). The total metal concentration in solution is kept at 0.5 M and fed (at a rate of 5 mL/min) through a capillary by a syringe pump and dispersed by 5 L/min oxygen forming a fine spray. The pressure drop at the capillary tip is kept constant at 1.5 bar by adjusting the orifice gap at the nozzle. The flame temperature is about 2000 K. Dilution air is introduced to cool the reaction products and the titanium dioxide is collected on filters.

Catalyst 2A has a specific surface area of 102 m²/gm and an anatase content (relative to total titania) of 93 wt. %.

Catalyst 2B

Catalyst 2B is prepared according to the procedure for 2A, with the exception that a precursor solution resulting in powders of 10 wt. % tungsta, 0.9 wt. % vanadia, 2 wt. % silica, and the balance TiO₂ is prepared by dissolving titanium isopropoxide (40.6 g), tungsten ethoxide (2.3 g), vanadium isopropoxide (0.38 g), and tetraethyl-orthosilicate (0.83 g) in toluene (300 mL).

Catalyst 2B has a specific surface area of 101 m²/gm and an anatase content (relative to total titania) of 95 wt. %.

Catalyst 2C

Catalyst 2C is prepared according to the procedure for 2A, with the exception that a precursor solution resulting in powders of 10 wt. % tungsta, 0.9 wt. % vanadia, 5 wt. % silica, and the balance TiO₂ is prepared by dissolving titanium isopropoxide (40.6 g), tungsten ethoxide (2.3 g), vanadium isopropoxide (0.38 g), and tetraethyl-orthosilicate (2.08 g) in toluene (300 mL).

Catalyst 2C has a specific surface area of 101 m²/gm and an anatase content (relative to total titania) of 96 wt. %.

### EXAMPLE 3

### Selective Catalytic Reduction Runs

NO conversion is determined using catalyst powders (1A-2C) in a fixed bed reactor. The composition of the reactor feed is 300 ppm NO, 360 ppm NH₃, 3 vol. % O₂, 10 vol. % H₂O, and balance N₂. Gas hourly space velocity (GHSV) is 83,000 h⁻¹ and reactor feed is up-flow to prevent pressure drop increases. Catalyst performance is measured at 220° C., 270° C. and 320° C. The measurements are made by first establishing steady state while passing the effluent stream through the reactor to determine the catalyst performance, and then bypassing the reactor to determine concentration measurements in the absence of reaction. Conversion is determined by the relative difference.

The results, in Table 1, show the catalysts produced by the method of the invention are significantly more active for the destruction of nitrogen oxide by ammonia compared to catalysts prepared by the conventional methods.

TABLE 1
SELECTIVE CATALYTIC REDUCTION RESULTS

| | | | NO Conversion | | |
|---|---|---|---|---|---|
| | Vanadia | Silica | at 218- | at 265- | at 312- |
| Catalyst | (wt. %) | (wt. %) | 222° C. | 270° C. | 320° C. |
| 1A * ¹ | 1.8 | 0 | 58 | 81 | 91 |
| 2A | 1.8 | 0 | 71 | 91 | 93 |
| 1B * | 0.9 | 9 | 15 | 39 | 67 |
| 2B | 0.9 | 2 | 22 | 68 | 85 |
| 2C | 0.9 | 5 | 36 | 76 | 90 |

* Comparative Example
¹ The 1A results are the average of two separate runs.

We claim:

1. A method for producing a metal oxide catalyst which comprises reacting a titanium dioxide precursor, a vanadium oxide precursor, and a tungsten oxide precursor in the presence of oxygen at a temperature of at least 1000° C.

2. The method of claim 1 wherein the titanium dioxide precursor is selected from the group consisting of titanium alkoxides and titanium halides.

3. The method of claim 1 wherein the vanadium oxide precursor is selected from the group consisting of vanadium halides, vanadium oxyhalides, vanadium alkoxides and vanadium acetylacetonate.

4. The method of claim 1 wherein the tungsten oxide precursor is selected from the group consisting of tungsten alkoxides, tungsten halides, tungsten oxyhalides, tungstic acid, and ammonium tungstate.

5. The method of claim 1 wherein the metal oxide catalyst comprises between 0.1 and 20 weight percent tungsten oxide, 0.2 and 10 weight percent vanadium oxide, and the balance titanium dioxide.

6. The method of claim 1 wherein the reaction occurs in the presence of an additional oxide precursor selected from the group consisting of a silica source, an alumina source, a ceria source, a lanthana source, a zirconia source, and mixtures thereof to form a metal oxide catalyst comprising titanium dioxide, vanadium oxide, tungsten oxide, and an additional oxide.

7. The method of claim 6 wherein the metal oxide catalyst comprises from 0.1 to 20 weight percent tungsten oxide, from 0.2 to 7 weight percent vanadium oxide, from 1 to 20 weight percent of additional oxide, and the balance titanium dioxide.

8. The method of claim 1 wherein a solution of the titanium dioxide precursor, vanadium oxide precursor, and tungsten oxide precursor is formed into droplets, and then flame oxidized.

9. The method of claim 1 wherein the titanium dioxide precursor, vanadium oxide precursor, and tungsten oxide precursor are fed simultaneously to the reaction.

10. The method of claim 1 wherein the titanium dioxide precursor, vanadium oxide precursor, and tungsten oxide precursor are fed separately to the reaction.

11. The method of claim 1 wherein the reaction occurs at a temperature between 1200 and 3000° C.

12. The method of claim 1 wherein the reaction occurs at a pressure in the range of 5 and 100 psig.
